(19) United States
(12) Patent Application Publication
(10) Pub. No.: US 2012/0315617 A1
(43) Pub. Date: Dec. 13, 2012

(54) SYSTEMS, METHODS, AND APPARATUS FOR USING A THEMATICALLY ORGANIZED MAP

(76) Inventor: Joshua Abraham Waitzkin, New York, NY (US)

(21) Appl. No.: 13/155,933

(22) Filed: Jun. 8, 2011

(51) Int. Cl. G09B 25/00

(52) U.S. Cl. 434/365

(57) ABSTRACT

A system, methods, and apparatus for using a thematically organized map are disclosed. In an example embodiment, elements of a first subject and a second subject are stored. The elements include local elements and non-local elements, and each element includes at least one element connection relationship. A thematically organized map representative of the elements connected according to the respective element connection relationships is displayed with the non-local elements and local elements are distinguishable from each other. The thematically organized map dynamically updates in response to a user interaction with a non-local element of the first subject to display the elements of the second subject, which are connected according to the respective element connection relationships.

### BACKGROUND

There are many forms of instructional and training systems and methods available to people that desire to learn new subjects or activities. People wanting or needing to learn or receive instruction, such as students or trainees, and people wanting to teach or provide instruction or training, instructors or trainers, generally prefer the ability to quickly and efficiently transfer knowledge from the instructor to the student. For example, remote education and remote training have gained in popularity, typically using the internet to provide educational, instructional, or training materials to students or trainees. Various methods allow for student interaction, which typically improves the student's ability to quickly and effectively increase his proficiency in the subject or activity at hand. Interaction may be with a computer program, an instructor, a trainer, a tutor, and/or with another student or trainee, and accordingly, may include dynamic interactivity.

Subjects to be learned typically include many elements or aspects that make up the subject matter at hand. Typically, a subject to be learned will be presented with a set of static material that is fundamental to the subject which is supplemented with dynamic material that may help fill in certain gaps for a student on an individual basis. Students or trainees may access information on an interactive basis to clarify points of uncertainty or improve on aspects of a craft. Interactive learning is typically desirable, particularly for highly complex or difficult to master subjects or activities. Dynamic material may be custom tailored for a student, for example an instructor answering a student's questions, or may be more generally tailored to answer frequent questions, provide additional instruction, or provide for practice on topics or in areas that are often difficult to comprehend or master. Many subjects and activities require a student to learn or master many different elements before the student becomes proficient in the subject or activity. Accordingly, improving a presentation of the elements of a subject may improve the efficiency of a student's progress.

### SUMMARY

The present disclosure provides a new and innovative system, methods and apparatus for using a thematically organized map. In one example embodiment, a elements of a first subject and a second subject are stored. The elements include local elements and non-local elements, and each element includes at least one element connection relationship. A thematically organized map representative of the elements connected according to the respective element connection relationships is displayed with the non-local elements and local elements are distinguishable from each other. The thematically organized map dynamically updates in response to a user interaction with a non-local element of the first subject to display the elements of the second subject, which are connected according to the respective element connection relationships.

Additional features and advantages of the disclosed method and apparatus are described in, and will be apparent from, the following Detailed Description and the Figures.

### BRIEF DESCRIPTION OF THE FIGURES

FIG. 1 is a high level block diagram of an example network communicating system, according to an example embodiment of the present invention.

FIG. 2 is a detailed block diagram showing an example of a computing device, according to an example embodiment of the present invention.

FIG. 3 provides an illustration of an example user interface displaying a thematically organized map, according to an example embodiment of the present invention.

FIG. 4 provides an illustration of an example thematically organized map, according to an example embodiment of the present invention.

FIGS. 5a and 5b provide an illustration of an example thematically organized map before and after a user interaction, according to an example embodiment of the present invention.

FIG. 6 provides an illustration of an example user interface displaying a thematically organized map, according to an example embodiment of the present invention.

FIG. 7 includes a flowchart illustrating an example process for navigating a thematically organized map, according to an example embodiment of the present invention.

FIG. 8 is a block diagram showing an example data architecture, according to an example embodiment of the present invention.

### DETAILED DESCRIPTION OF EXAMPLE EMBODIMENTS

The present disclosure relates in general to a system for presenting information and, in particular, to a system, methods, and apparatus for using a thematically organized map. Briefly, in an example embodiment, a system is provided which allows a user to use a thematically organized map to learn some subject or skill set, such as the martial art of Brazilian Jiu Jitsu, on an online training or instruction website. The system may generate an interactive and dynamic map that embodies the lifecycle of Brazilian Jiu Jitsu.

For example, the system may include a host server which stores the elements of Brazilian Jiu Jitsu, and displays those elements using a thematically organized map, which displays the interconnections of the elements. The elements of Brazilian Jiu Jitsu include local elements such as techniques, which may relate to positions, submissions, transitions, and principles. The relationships of these elements may be illustrated on the map using element symbols and relationship connection lines. The elements of Brazilian Jiu Jitsu also include non-local elements such as principles, which are connected with the local elements and also with non-local elements of other subjects.

In this example embodiment, the user may interactively navigate the map by changing the focus from element to element. For example, the user may start at a position and view the submissions associated with that position. The user may change the focus of the map to a submission, which then leads the user to view a principle. Next, the user may change the focus of the map to the principle, which may provide diverse non-local elements of which the user may have an existing knowledge. Thus, by thematically organizing the elements of the subject matter, and by allowing the user to interactively and dynamically navigate the map, the user may learn the elements of Brazilian Jiu Jitsu using thematic interconnectedness. Students are typically compartmentalized learners that can benefit from associating an element to be learned with an element that is already known with a principle applicable to both elements. The presently disclosed thematically organized map may allow a user to harness the thematic interconnectedness of the principles of Brazilian Jiu Jitsu with the principles of, for example, chess, wood working, or business negotiations, which may improve the efficiency and quality of the learning process. Accordingly, the presently disclosed thematically organized map may allow a user to remove false barriers between diverse arts.

Additionally, in an example embodiment, training content such as video segments may be available on a website and may be accessed using the thematically organized map. Further, the thematically organized map may be used to access other training content such as the video segments. For example, the presently disclosed system may be used in conjunction with the system disclosed in U.S. patent application Ser. No. 12/880,305, filed on Sep. 13, 2010, and entitled “Instruction and Training System, Methods, and Apparatus,” the entire contents of which are hereby incorporated by reference herein. In an example embodiment, a thematically organized map will include a wide array of elements that are searchable in a video database.

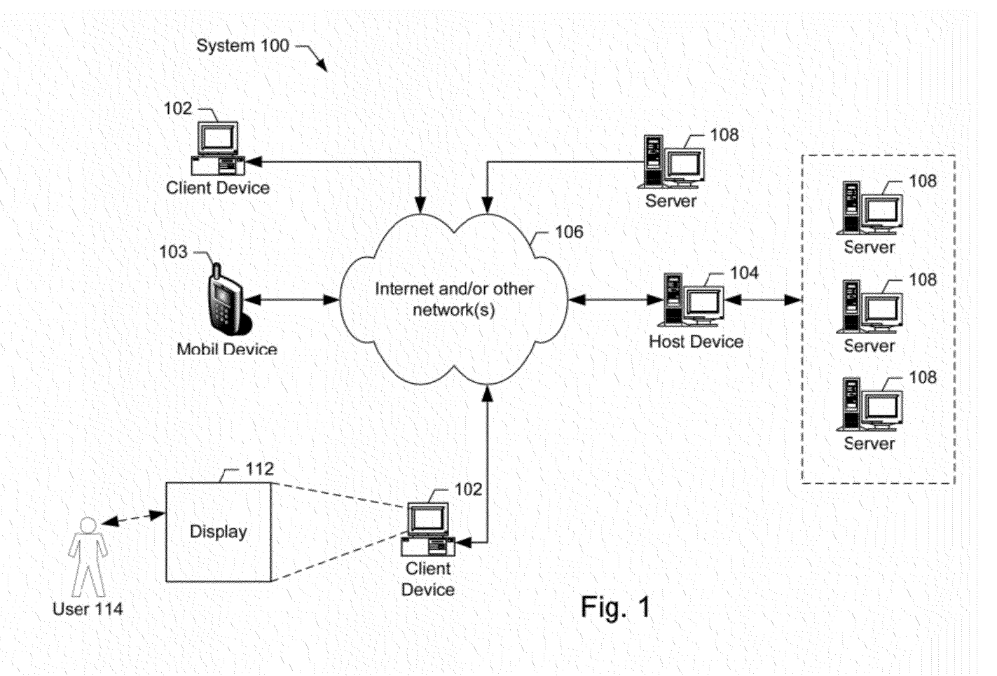

The present system may be readily realized in a network communications system. A high level block diagram of an example network communications system 100 is illustrated in FIG. 1. The illustrated system 100 includes one or more client devices 102, and one or more host devices 104. The system 100 may include a variety of client devices 102, such as a mobile device 103, which may be a cellular phone, a personal digital assistant, a laptop computer, a tablet computer, etc. The client devices 102 may communicate with the host device 104 via a connection to one or more communications channels 106 such as the Internet or some other data network, including, but not limited to, any suitable wide area network or local area network. It should be appreciated that any of the devices described herein may be directly connected to each other instead of over a network.

One host device 104 may interact with a large number of users 114 at a plurality of different client devices 102. Accordingly, each host device 104 is typically a high end computer with a large storage capacity, one or more fast microprocessors, and one or more high speed network connections. Conversely, relative to a typical host device 104, each client device 102 typically includes less storage capacity, a single microprocessor, and a single network connection.

Each host device 104 stores one or more of a plurality of files, programs, databases, and/or web pages in one or more memories for use by the client devices 102. A host device 104 may be configured according to its particular operating system, applications, memory, hardware, etc., and may provide various options for managing the execution of the programs and applications, as well as various administrative tasks. A host device 104 may interact via one or more networks with one or more other host devices 104, which may be operated independently. For example, many host devices 104 operated by a separate and distinct entities may interact together according to some agreed upon protocol.

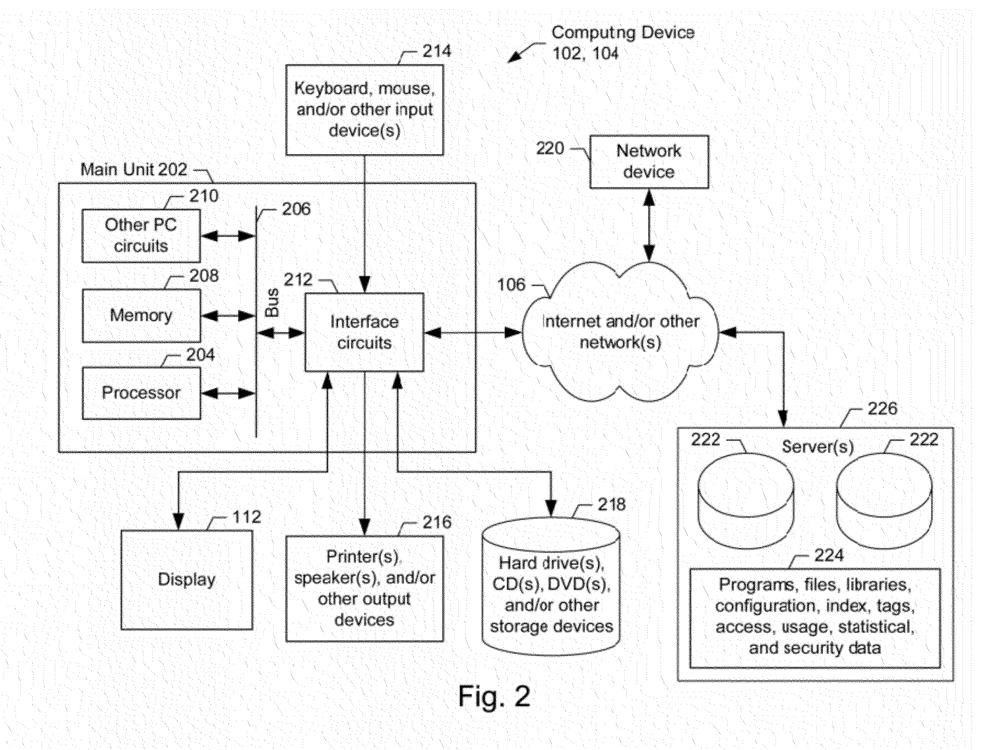

A detailed block diagram of the electrical systems of an example computing device (e.g., a client device 102, and a host device 104) is illustrated in FIG. 2. In this example, the computing device 102, 104 includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIUM® family of microprocessors. The memory 208 preferably includes volatile memory and non-volatile memory. Preferably, the memory 208 stores a software program that interacts with the other devices in the system 100 as described below. This program may be executed by the processor 204 in any suitable manner. The memory 208 may also store digital data indicative of documents, files, programs, web pages, etc. retrieved from a computing device 102, 104 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays 112, printers, speakers, and/or other output devices 216 may also be connected to the main unit 202 via the interface circuit 212. The display 112 may be a cathode ray tube (CRTs), a liquid crystal display (LCD), or any other type of display. The display 112 generates visual displays generated during operation of the computing device 102, 104. For example, the display 112 may provide a user interface, which will be described in further detail below, and may display one or more web pages received from a computing device 102, 104. A user interface may include prompts for human input from a user 114 including links, buttons, tabs, checkboxes, thumbnails, text fields, etc., and may provide various outputs in response to the user inputs, such as still images, videos, audio, animations, and text.

One or more storage devices 218 may also be connected to the main unit 202 via the interface circuit 212. For example, a hard drive, CD drive, DVD drive, and/or other storage devices may be connected to the main unit 202. The storage devices 218 may store any type of data, such as image data, video data, audio data, tagging data, historical access or usage data, statistical data, security data, etc., which may be used by the computing device 102, 104.

The computing device 102, 104 may also exchange data with other network devices 220 via a connection to the network 106. Network devices 220 may include one or more servers 226, which may be used to store certain types of data, and particularly large volumes of data, for example, video data stored in one or more data repository 222. However, a server 226 may include any kind of data 224 including programs, files, libraries, configuration data, index or tagging data, historical access or usage data, statistical data, security data, etc. A server 226 may store and operate various applications relating to receiving, transmitting, processing, and storing the large volumes of data. It should be appreciated that various configurations of one or more servers 226 may be used to support and maintain the system 100. Also, certain data may be stored in a client device 102 which is also stored on the server 226, either temporarily or permanently, for example in memory 208 or storage device 218. The network connection may be any type of network connection, such as an Ethernet connection, digital subscriber line (DSL), telephone line, coaxial cable, etc. Access to a computing device 102, 104 can be controlled by appropriate security software or security measures. An individual users' access can be defined by the computing device 102, 104 and limited to certain data and/or actions. Accordingly, users 114 of the system 100 may be required to register with one or more computing devices 102, 104. For example, registered users 114 may be able to manipulate data, such as by tagging element data or video content, providing discussion text or notes, submitting or uploading video content, rating content, suggesting content to other users 114, etc.

As noted previously, various options for managing data located within the computing device 102, 104 and/or in a server 226 may be implemented. A management system may manage security of data and accomplish various tasks such as facilitating a data backup process. A management system may be implemented in a client 102, a host device 104, and a server 226. The management system may update, store, and back up data locally and/or remotely. A management system may remotely store data using any suitable method of data transmission, such as via the Internet and/or other networks 106.

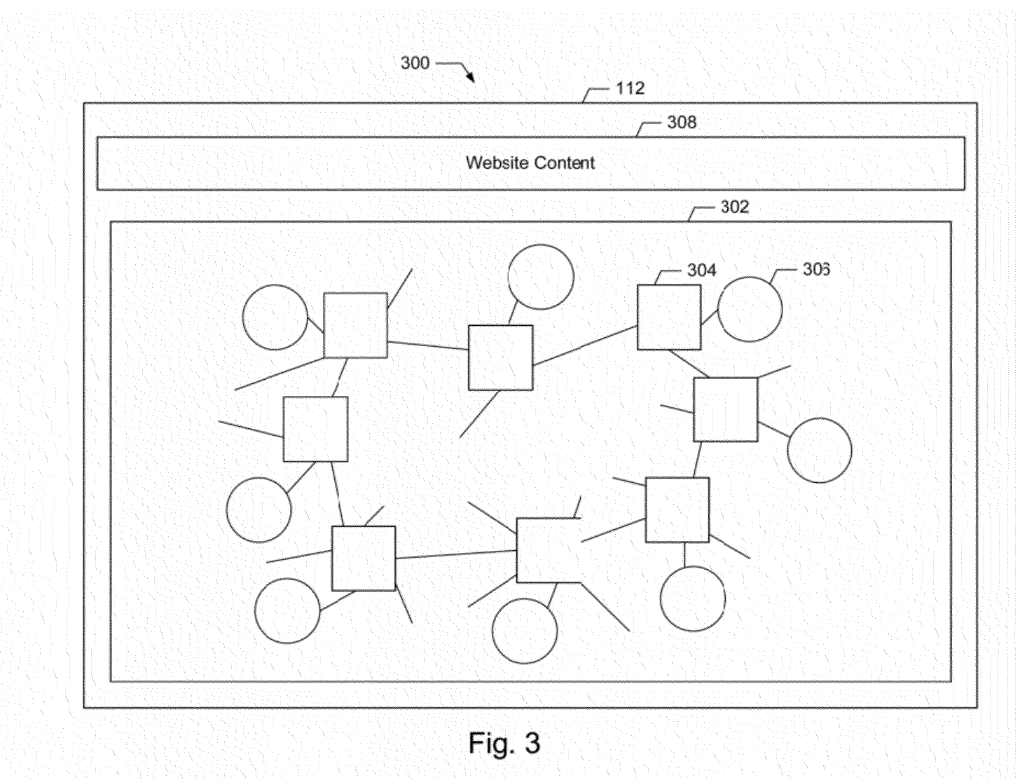

FIG. 3 provides an example user interface 300 displaying an example thematically organized map 302. In this example, the user interface 300 is illustrated as a web page which provides a thematically organized map 302 relating to martial arts or self defense, for example purposes, Brazilian Jiu Jitsu. It should be appreciated that the same system may apply to wrestling, judo, boxing, karate, etc. It should also be appreciated that the user interface 300 may similarly provide a thematically organized map 302 for various other subjects, including various vocational applications, recreational applications, and competitive applications, for example, sports and games (e.g., where the subject is a department of knowledge or that which forms a basic matter of thought, discussion, investigation such as Brazilian Jiu Jitsu or chess). Further, it should be appreciated that a user interface 300 may be implemented using both a visual display of information (e.g., on display 112) as well as audio or other output stimuli for an improved user experience. Typically, a web browser is used to display a web page on a client device 102. For exemplary purposes, the visual aspect of the user interface 300 with the thematically organized map 302 is discussed in detail with respect to martial arts or self defense techniques, and more particularly, as an example, Brazilian Jiu Jitsu.

A user 114 may view the example user interface 300 on the display 112. The example user interface 300 includes an area to display a thematically organized map 302 which includes local elements 304 (e.g., the squares) and non-local elements 306 (e.g., the circles), and a website content area 308. It should be appreciated that a web page layout may allocate the space for each section of the user interface 300 according to the specific type of content which will be displayed. Further, it should be appreciated that advertisements and various other sections may readily be incorporated in a user interface 300, and that the example areas explained may be combined or modified in various ways. Also, it should be appreciated that the user interface 300 may not only be visually displayed on the display 112, but may also be provided via other output mechanisms such as speakers 216, and uses input devices 214 such as a keyboard and mouse.

As illustrated in FIG. 3, the exemplary thematically organized map 302 organizes the local elements 304 (e.g., where the local element is an element characteristic of, involving, or affecting elements of a subject such as a guillotine choke or a pawn structure) and non-local elements 306 (e.g., where the non-local element is an element characteristic of, involving, or affecting elements of more than one subject such as imposing your game or downward spiral) according to each element's 304, 306 respective relationship to the other elements 304, 306. An element connection relationship is designated by a line connecting each element 304, 306 to at least one other element 304, 306. The relationships of the elements 304, 306 may be one to one, one to many, or many to many. The local elements 304 may be displayed using different shapes or colors than the non-local elements 306, thus allowing the user 114 to easily distinguish between the local elements 304 and non-local elements 306. For example, the local elements 304 are displayed as squares and the non-local elements 306 are displayed as circles.

The example thematically organized map 302 may allow the user 114 to have customized settings for the specific display style of local elements 304 and non-local elements 306 to allow the user 114 to easily distinguish each desired category of elements 304, 306. The user 114 may have options to vary the display of the thematically organized map 302, for example, by zooming in or out, scrolling, changing the window size (e.g., maximizing the thematically organized map 302), etc. Also, the amount of information displayed for each element 304, 306 may be dynamically changed. For example, an element 304, 306 may initially display only a title or name of the element 304, 306, but if the user 114 clicks on, hovers over, or otherwise interacts with the element 304, 306, additional information is displayed. The additional information may include text, images, video segments, links to other content, and the like. Additional information may be displayed in any suitable manner, such as window, balloon, or bubble which appears over, inside, or near the element 304, 306, or in some other designated area of the user interface 300. It should be appreciated that an element 304, 306, as used herein, may refer to a graphical representation of an element 304, 306 and/or the data relating to the element 304, 306. For example, in the context of Brazilian Jiu Jitsu, a “guillotine choke” may be an element 304, which may refer to a graphical representation which represents the guillotine choke on a thematically organized map 302, and may also refer to the data associated with the guillotine choke which is stored and accessible to the user 114 through the thematically organized map 302. In the context of chess, an example of a local element 304 may be a pawn structure. Accordingly, as discussed in further detail below, an element 304, 306 may include both the user perceptible information relating to the element 304, 306, as well as the data embodying that information which is available to the user 114, for example, data stored in a memory device or data displayed on a screen.

The thematically organized map 302 may have a default display, which the user may dynamically change by interacting with the elements 304, 306, for example, by clicking or double-clicking on an element 304, 306. This may bring the focus to the selected element 304, 306 and the thematically organized map 302 may automatically adjust by changing the size, position, layout, etc. of the elements 304, 306. Accordingly, the display of the elements 304, 306 are dynamically changing based on the user 114 selections on the user interface 300.

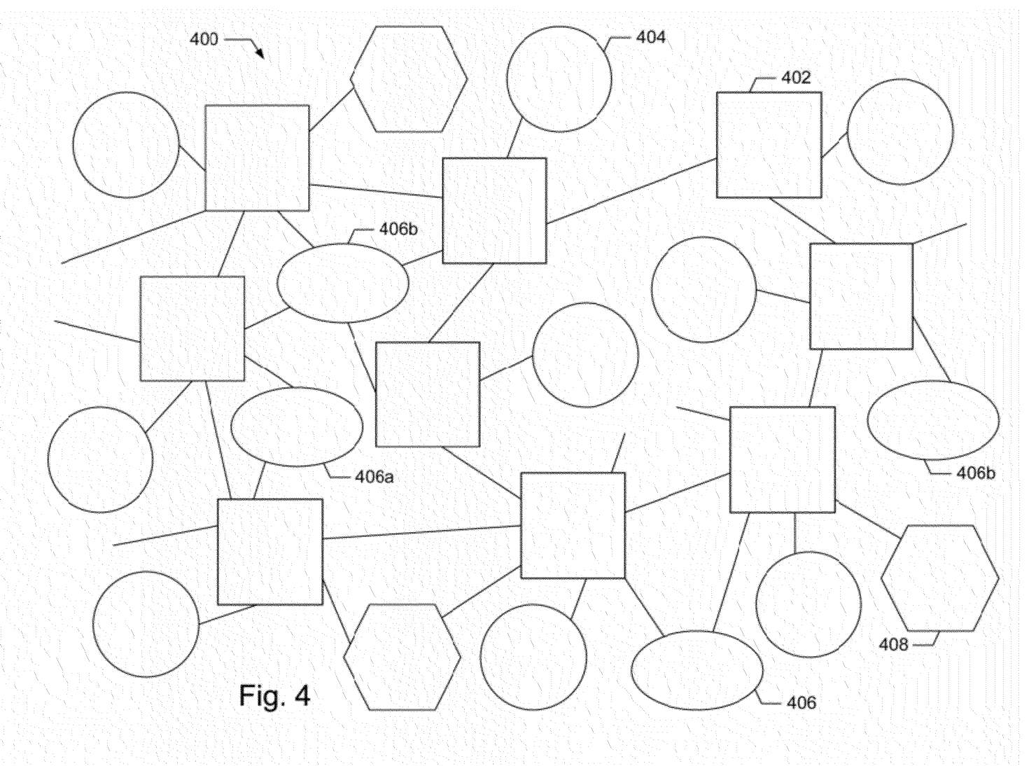

FIG. 4 provides an illustration of an example thematically organized map 400. For example purposes, thematically organized map 400 includes the elements of Brazilian Jiu Jitsu, which may include techniques, positions, transitions, and principles. In this example embodiment, a position 402 is designated with a square while a technique such as a submission 404 is designated with a circle. In this example thematically organized map 400, positions 402 and submissions 404 are examples of two types of local elements 304 that are specific to the subject matter of Brazilian Jiu Jitsu. The positions 402 each have at least one element connection relationship to another element (e.g., a submission 404). Likewise, the submissions 404 each have at least one element connection relationship to another element (e.g., a position 402). Accordingly, specific types of local elements 304 (e.g., positions 402 shown as squares) may be distinguishable from other types of local elements 304 (e.g., submissions 404 shown as circles). It should be appreciated that a position 402 may be considered a specific type of technique, but that it may be useful to differentiate a position from other types of techniques for display on the thematically organized map 400. For example, a particular submission (e.g., guillotine choke), may appear in several different locations on the thematically organized map 400 because the particular submission 404 may be executed in various different positions 402. Accordingly, differentiating between positions 402 and submissions 404 may provide additional information that the user 114 finds useful. Also, it should be appreciated that positions 402 designated with a square may include transitions, or transitions may have a different designation shape or other distinguishable characteristic. The display designations for different elements 304, 306 or types of elements may be adjusted based on the specific application at hand.

Another type of local element 304 may be a local principle 406, which may be a core concept or theoretical idea that is specific to Brazilian Jiu Jitsu, but may not be applicable to other subjects. In the example thematically organized map 400, a local principle 406 is designated by an ellipse or oval shape. A local principle 406 relates to at least two different local elements 304. As illustrated in FIG. 4, local principle 406a relates to two different positions 402, and local principle 406b relates to five different positions 402. The local principle 406b is shown on the left side of the thematically organized map 400 with element connection relationships to four positions 402, and with a single element connection relationship to one position 402 on the right side of the thematically organized map 400. The thematically organized map 400 may be organized in such a fashion where the same element 304, 306 may appear in more than one place to provide an improved arrangement of elements 304, 306 for the user's 114 viewing. Also, in some instances, elements 304, 306 of lesser importance or which bear more remote relationships may not be displayed, or may be displayed with a smaller size or diminished presence.

Further, in this example embodiment, non-local elements 306, for example, non-local principles 408 may be displayed as hexagons. A non-local principle 408 may be a core concept or theoretical idea that is not specific to Brazilian Jiu Jitsu, but may apply to other subjects as well. For example, a non-local principle 408 applicable to Brazilian Jiu Jitsu may also apply to chess (e.g., setting the tone of battle, downward spiral, imposing your game). A non-local principle 408 may apply to one or more positions 402. Similarly, a non-local principle 408 may be applicable to one or more submissions 404. All non-local principles 408 are applicable to at least one element of a different subject matter. In the example thematically organized map 400, elements of another subject are not initially shown. However, for example, a user 114 may click on a non-local principle 408 to bring elements of one or more other subjects into the thematically organized map 400, so the user 114 may view that specific non-local principle 408 in the context of a different subject matter.

Further, if a user 114 is studying Brazilian Jiu Jitsu, a thematically organized map 400 with the elements 304, 306 of the subject of Brazilian Jiu Jitsu may be displayed for analysis. However, it should be appreciated that the subject matter of the thematically organized map 400 may be context dependent in certain instances. For example, a first thematically organized map 400 displayed may relate to the subject of offense, while a second thematically organized map 400 displayed may relate to the subject of defense. An offense related thematically organized map 400 may have non-local elements 306 that relate to a defense related thematically organized map 400, which may allow a user analyzing an offensive element to access related defensive elements, or vice versa. The subjects of offense and defense may both relate to Brazilian Jiu Jitsu, but the subject matter which is the focus of a thematically organized map 400 may dictate whether an element 304 is a local element or a non-local element 306. Similarly, subjects may be position specific, for example, the guard position may be a different subject than the mount position. Accordingly, it should be appreciated that an element which is a local element 304 in a first thematically organized map 400 may be a non-local element in a second thematically organized map 400.

Additionally, the thematically organized map 400 may be navigated while using other platforms and tools for instruction or training to further aid the user 114. The thematically organized map 400 may include, for certain elements 304, 306, information pertaining to a specific element 304, 306, such as attempt and success rates in the form of probabilities. For example, from a certain position 402 (e.g., guard position), the position 402 may display attempt and success rates for certain other local elements 304 such as submissions 404 (e.g., a guillotine choke). For example, a measure of how often a particular submission 404 is attempted in a given situation and how often that submission 404 will be successful, may be provided. Such analytics may provide a user 114 with an insight into which routes of navigation through the thematically organized map 400 may be most beneficial to the user 114.

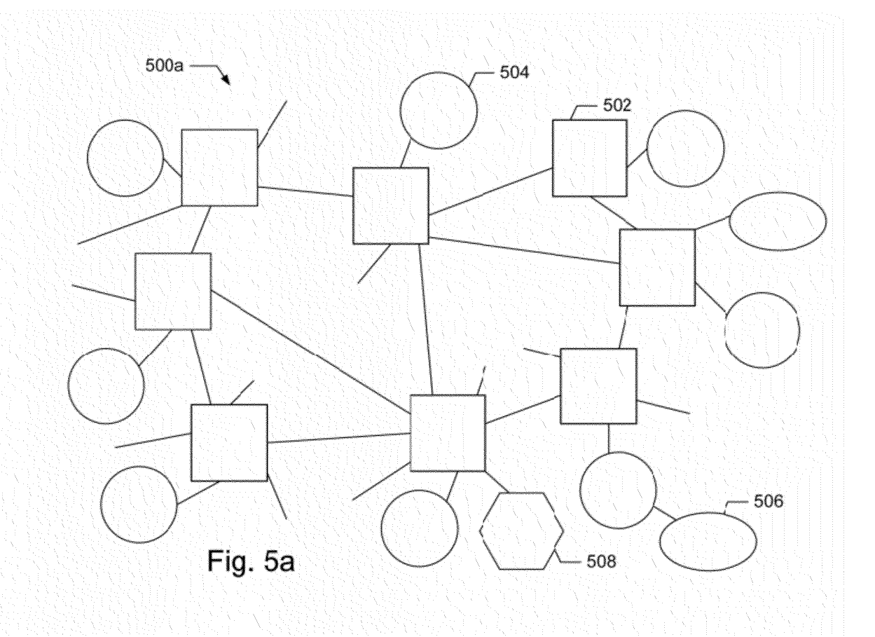

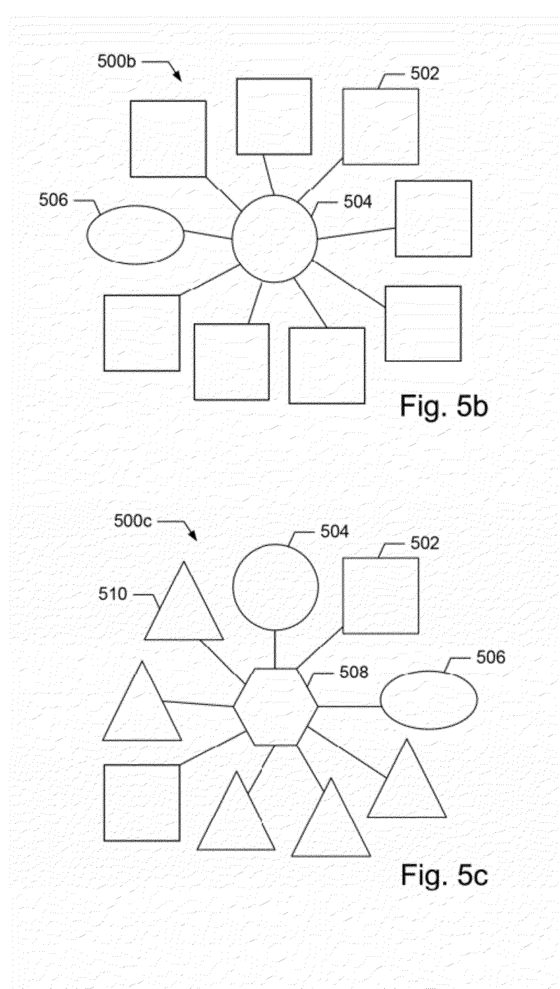

FIGS. 5a, 5b, and 5c provide an illustration of an example thematically organized map 500, which is shown before a user interaction as thematically organized map 500a, and after the user interaction as thematically organized map 500b or thematically organized map 500c. The example thematically organized map 500 includes positions 502 (e.g., guard, top mount), submissions 504 (e.g., guillotine choke, arm bar), local principles 506 (e.g., creating a frame), and non-local principles 508 (e.g., setting the tone of battle, downward spiral, imposing your game). A user viewing the thematically organized map 500a may decide to focus on a specific submission 504, for example, the guillotine choke. Upon interacting with the thematically organized map 500a, for example, double-clicking the submission 504 (e.g., the guillotine choke element), the thematically organized map 500a may dynamically update to display the submission 504 (e.g., the guillotine choke element) at the center of the thematically organized map 500b, with the positions 502 and local principles 506 that have an element connection relationship with the selected submission 504 (e.g., the guillotine choke element). Further, for example, a user viewing the thematically organized map 500a may decide to focus on a specific non-local principle 508, for example, the downward spiral. Upon interacting with the thematically organized map 500a, for example, double-clicking the non-local principle 508, the thematically organized map 500a may dynamically update to display the non-local principle 508 at the center of the thematically organized map 500c, with the positions 502, submissions 504, and local principles 506 that have an element connection relationship with the selected non-local principle 508 (e.g., the downward spiral). Also, non-local elements 510, which are elements that are local to a different subject matter (e.g., chess, business), appear on the thematically organized map 500c. It should be appreciated that dynamically updating or focusing a thematically organized map 500a may be implemented in a wide variety of ways. For example, a thematically organized map 500a may be re-centered, rearranged, zoomed in or out, etc., and elements 304, 306 may be added and/or removed based on user interactions which result in a dynamically updated thematically organized map 500b, 500c, which may then again be dynamically updated based on a user's next interaction.

The ability to dynamically update a thematically organized map 500a may maximize the impact of what a user 114 is learning. For example, if a user spends time studying a particular element 304, such as a submission 504, the user 114 may quickly interact with the thematically organized map 500a to generate and display a visual representation of all the positions 502 in which the submission 504 may be used. Accordingly, the user 114 may study the thematic interconnectedness of the subject, which may teach the user 114 to get to the core of creativity by thinking thematically. For example, by learning one element 304, 306, the user 114 may be guided to many other related elements 304, 306 to which the user 114 can then apply his existing knowledge. Preferably, using a thematically organized map 500 may teach a user 114 to make thematic connections on his own by thinking in terms of local elements 304 and non-local elements 306, rather than thinking solely of some specific local element 304 at hand.

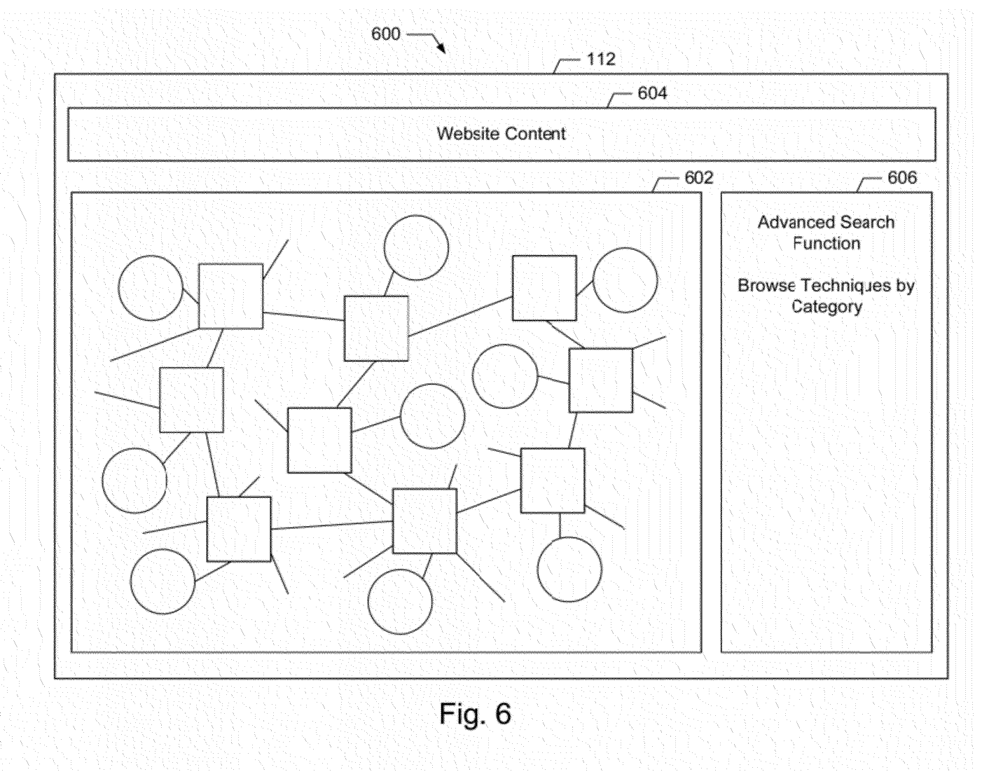

FIG. 6 provides an illustration of an example user interface 600 displaying a thematically organized map 602. In this example embodiment, the user interface 600 includes a website content area 604 and a search and browse area 606 within the user interface 600 which allows a user 114 to search or browse a menu. The user's 114 searching or browsing may generate a thematically organized map 602 which is focused on a specific element, or may be based on a specific elemental organization structure that the user 114 is interested in. For example, the user 114 may enter a search term such as a particular type of technique, position, principle, or situation. For example, a user 114 may enter “guard position” into the search and browse area 606 which will provide a thematically organized map 602 that is organized relative to the guard position, with other related elements connected to the guard position. It should be appreciated that such as search a browse area 606 may be used in conjunction with a video search database or other instructional or training tools or function.

The user 114 may navigate to a specific area of the thematically organized map 602 based on the user's 114 desired area of focus via the thematically organized map 602 or via the search and browse area 606. Accordingly, a user 114 may navigate the thematically organized map 602 based on the user's 114 individual interests and current level of knowledge. In this way, the disclosed system may provide the user 114 with the ability to organically move between related elements within a subject (e.g., local elements 304) and related elements between subjects (e.g., non-local elements 306).

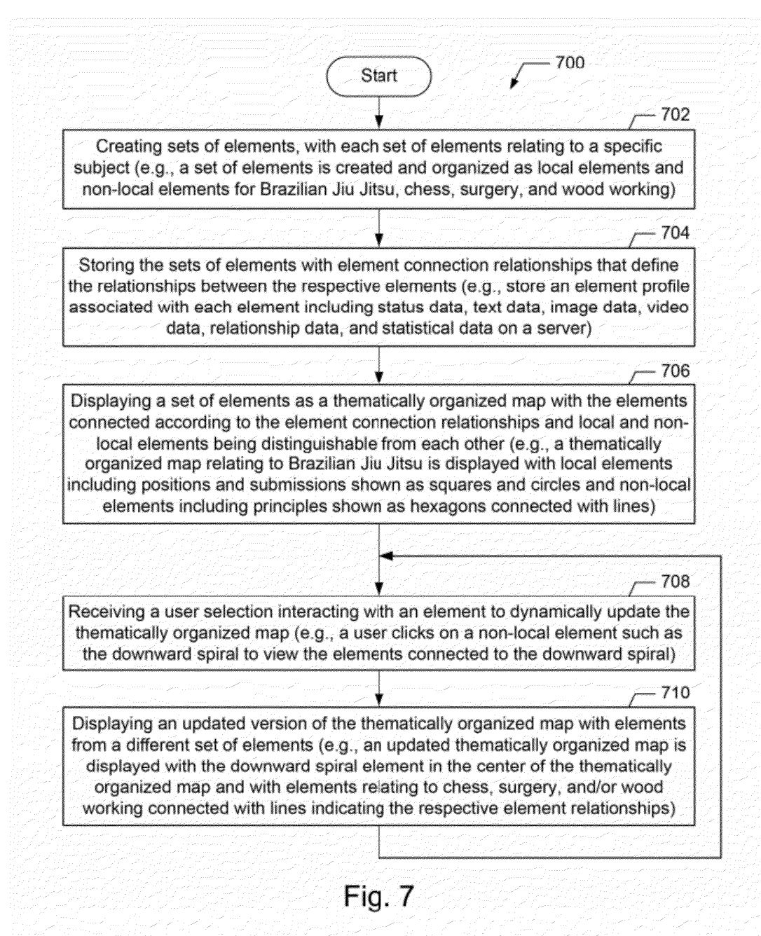

FIG. 7 is a flowchart of an example process 700 for providing a thematically organized map 302, 400, 500, 602. Although the process 700 is described with reference to the flowchart illustrated in FIG. 7, it will be appreciated that many other methods of performing the acts associated with the process 700 may be used. For example, the order of many of the blocks may be changed, and many of the blocks described are optional.

The example process 700 for providing a thematically organized map 302, 400, 500, 602 allows users 114 to navigate through elements on the thematically organized map 302, 400, 500, 602. The example process 700 may begin with creating sets of elements 304, 306, with each set of elements 304, 306 relating to a specific subject (block 702). For example, a set of elements 304, 306 is created and organized as local elements 304 and non-local elements 306 for Brazilian Jiu Jitsu, chess, surgery, and wood working. Each element 304, 306 may have an element profile which is associated with the element 304, 306 and contains information which will be displayed to represent the element 304, 306. For example, an element 304, 306 may have one or more of a title, a description, a primary image, an icon, a video segment, and/or a link to additional materials. The element profiles may include one or more categorizations of the element 304, 306 which may aid in organization of the element 304, 306 among other elements 304, 306, including status, relationship data, tagging data, statistical data, and the like. It should be appreciated that elements 304, 306 may be tagged or otherwise associated with various data to create and maintain an organized database of element data.

The example process 700 may continue with storing the sets of elements 304, 306 with element connection relationships that define the relationships between the respective elements (block 704). For example, an element profile associated with each element 304, 306 including status data, text data, image data, video data, relationship data, and statistical data is stored on a server. An element 304, 306 may have a single element profile which includes all the data associated with that element 304, 306, or the element 304, 306 may have associated data stored in a distributed manner in multiple files on one or more servers 226. The particular implementation may be based on a variety of factors such as the volume of data associated with the elements 304, 306 of any subjects which may be displayed on a thematically organized map 302, 400, 500, 602.

A set of elements 304, 306 are displayed as a thematically organized map 302, 400, 500, 602 with the elements 304, 306 connected according to the element connection relationships and local elements 304 and non-local elements 306 being distinguishable from each other (block 706). For example, a thematically organized map 302, 400, 500, 602 relating to Brazilian Jiu Jitsu is displayed with local elements 304 including positions 402 and submissions 404 shown as squares and circles and non-local elements 306 including principles 408 shown as hexagons connected with lines. Each element 304, 306 displayed in the thematically organized map 302, 400, 500, 602 includes one or more element connection lines illustrating the relationship between the respective elements 304, 306. For example, a thematically organized map 302, 400, 500, 602 may initially appear in a default setting which shows all elements 304, 306 relating to a subject. Also, for example, a default setting of the thematically organized map 302, 400, 500, 602 may only display some subset of elements 304, 306 that only includes the most important elements 304, 306 or the most commonly used elements 304, 306. If all elements 304, 306 relating to a subject are initially shown, some element connection relationship may not be shown on the thematically organized map 302, 400, 500, 602, which may be quite large and having many element connection relationships. In some cases, the thematically organized map 302, 400, 500, 602 may be better suited to omit some elements 304, 306 and/or element connection relationships so the thematically organized map 302, 400, 500, 602 is not overloaded with content.

Next, a user selection interacting with an element 304, 306 is received to dynamically update the thematically organized map 302, 400, 500, 602 (block 708). For example, a user 114 clicks on a non-local element 304 such as the downward spiral to view the elements 304, 306 connected to the downward spiral. For example, a user 114 may notice that the downward spiral element is connected to a Brazilian Jiu Jitsu technique the user 114 is studying, and the user 114 may wish to see additional elements 304, 306 that relate to the downward spiral. The user 114 may interact with the thematically organized map 302, 400, 500, 602 by selecting an element 304, 306, zooming in or out, or otherwise indicating that the user 114 wishes to view different or additional information. It should be appreciated that a user interaction may be a single action or a series of actions, for example, a user 114 may hover over or double-click on an element 304, 306, and then click on a button or some other graphic, confirmation or selection function. Also, a user 114 may typically interact with any type of element 304, 306 that is displayed on the thematically organized map 302, 400, 500, 602 or a user 114 may interact with some other form of controls on the user interface 300, for example, a search or browse function, a default setting, a back button, a history, or the like.

In response to the user interaction, an updated version of the thematically organized map 302, 400, 500, 602 with elements 304, 306 from a different set of elements 304, 306 is displayed (block 710). For example, an updated thematically organized map 302, 400, 500, 602 is displayed with the downward spiral element in the center of the thematically organized map 302, 400, 500, 602 and with elements 304, 306 relating to chess, surgery, and/or wood working connected with lines indicating the respective element relationships. The user 114 may have a thorough understanding of different subjects such as chess, surgery, or wood working, which the thematically organized map 302, 400, 500, 602 may dynamically display in response to the user interaction. Accordingly, viewing elements 304, 306 relating to chess, surgery, and/or wood working which are related to the downward spiral element may allow the user 114 to take a concept which is already understood and relate that concept to the subject to be learned. It should be appreciated that some interactions with a thematically organized map 302, 400, 500, 602 may not introduce any new elements 304, 306 into the thematically organized map 302, 400, 500, 602. For example, clicking on a local element 304 may rearrange or re-center the elements 304, 306 of a thematically organized map 302, 400, 500, 602 without adding any new elements 304, 306. Additional element connection relationships may appear which were not shown prior to the user interaction, and/or existing element connection relationships may be removed based on a user interaction. Additional elements 304, 306 and/or element connection relationships may be added if a user 114 zooms in on a section of the thematically organized map 302, 400, 500, 602, because additional space may be provided to display the elements 304, 306 and/or element connection relationships. Also, elements 304, 306 deemed to be less important or otherwise unnecessary may be removed based on a user interaction.

Accordingly, the user 114 may be led to through a thematically organized map 302, 400, 500, 602, from one element 304, 306 to the next, and may be led to elements 304, 306 in different subjects. For example, a user 114 may dynamically be led to a new principle 408 through the study of a technique 402, 404, or alternately, may be led to a new technique 402, 404 through the study of a principle 408. A specific example in the context of Brazilian Jiu Jitsu may be that a user 114 may be studying the guard position 402 and may be led to study a principle 408 of setting the tone of battle, and then, led from the principle 408 of setting the tone of battle to an element 304, 306 which is already understood in a different subject, such as chess, for example a pawn structure element 304. The user 114 may continue dynamically navigating the thematically organized map 302, 400, 500, 602 based on the information which is being digested. Accordingly, the user 114 may learn in a natural and fluid manner, following the thematically organized map 302, 400, 500, 602 based on the information already known to the user 114 and the information the user 114 desires to learn. It should be appreciated that a thematically organized map 302, 400, 500, 602 may be implemented for any subject which a user 114 may desire or need to learn, and that a thematically organized map 302, 400, 500, 602 may be beneficially used independently or in conjunction with other instruction and training systems or methods to educate, instruct, and train users 114 of the disclosed system.

Also, it should be appreciated that, while the process 700 typically may use a network 106 to provide a client device 102 with the content for display to a user 114, it should be appreciated that in an example embodiment, the process 700 may be performed in a host device 104 acting as a stand alone terminal which does not send or receive data over a network 106. Further, the host device 104 may interact with a separate host device 104, which may be operated by a distinct entity. For example, one company may operate a website which provides a thematically organized map 302, 400, 500, 602 relating to Brazilian Jiu Jitsu, and a separate company may provide a thematically organized map 302, 400, 500, 602 relating to chess. Accordingly, a host device 104 may specialize in one or more specific subjects, and interface via one or more networks 106 with one or more other host devices. In an example embodiment, a large number of host devices 104 may operate together, such that elements 304, 306 from many different subjects may be interfaced together, which may allow a user 114 to, for example, study a given principle 408 through the lens of various different arts.

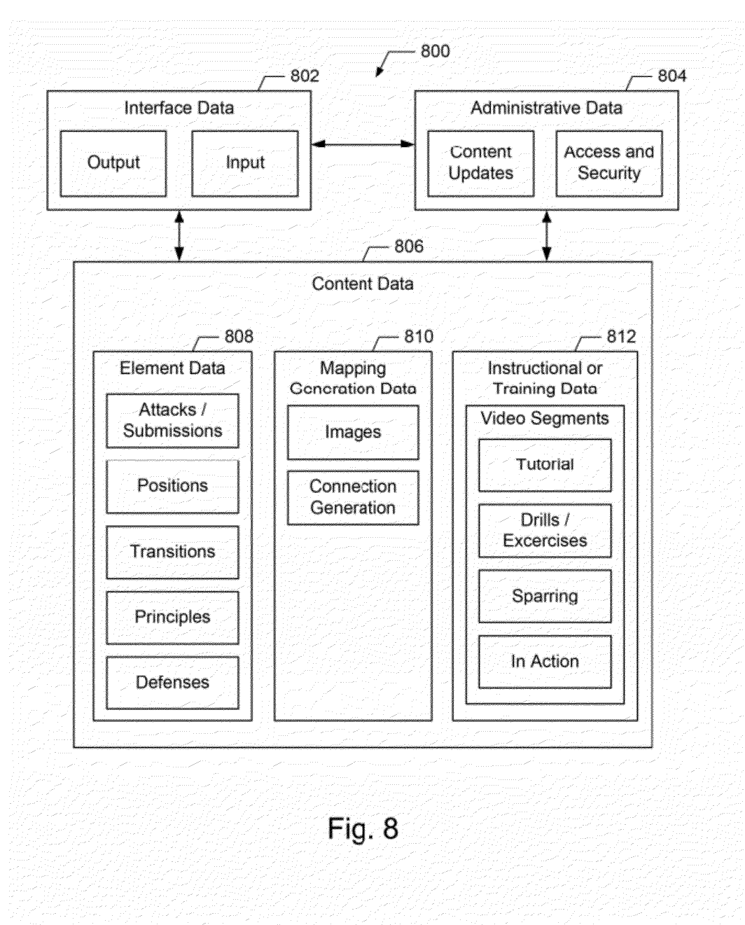

FIG. 8 illustrates a block diagram of an example data architecture 800. In the example data architecture 800, interface data 802, administrative data 804, and content data 806 interact with each other, for example, based on user commands or requests. The interface data 802, administrative data 804, and content data 806 may be stored on any suitable storage medium (e.g., server 226). It should be appreciated that different types of data may use different data formats, storage mechanisms, etc. Further, various applications may be associated with processing interface data 802, administrative data 804, and content data 806. Various other or different types of data may be included in the example data architecture 800.

Interface data 802 may include input and output data of various kinds. For example, input data may include mouse click data, scrolling data, hover data, keyboard data, touch screen data, voice recognition data, etc., while output data may include image data, text data, video data, audio data, etc. Interface data 802 may include request data, suggestion data, survey data, advertising data, and the like. Interface data 802 may include applications used to provide or monitor interface activities and handle input and output data.

Administrative data 804 may include content update data and applications for updating content data or data related to content. Further, administrative data 804 may include access data and/or security data. Administrative data 804 may interact with interface data in various manners, providing a user interface 300 with administrative features, such as implementing a user login, gathering user statistics, providing advertising content, and the like.

Content data 806 may include various types of content, for example, element data 808 which may be organized by subject, mapping generation data 810 such as images and files used to generate a thematically organized map 302, 400, 500, 602, and various other instructional or training data 812, such as video segments. Content data 806 may be stored and/or organized within a relational database system. It should be appreciated that different content data types may be stored in accordance with system requirements. For example, mapping generation data 810 may be stored in an image server, video segments may be stored in a video server, and element data 808 including relational tagging data may be stored in a database server. The content data 806 may be organized and indexed according to a predetermined scheme. For example, in the context of a Brazilian Jiu Jitsu thematically organized map 302, 400, 500, 602, element data 808 for every local element 304 may be tagged as an attack, a submission, a position, a transition, a principle, and/or a defense. Any elements 304, 306 may be appropriately tagged with a variety of information, including information relating to local and/or non-local connections of the elements 304, 306. It should be appreciated that elements 304, 306 may include any form of information, in the form of stored data, and typically include text, image, and video data. It should further be appreciated that content data 806 of various types may be related to other types of content data 806. For example, administrators may provide and/or update content relationships (e.g., using a relational database), which are used by users 114 to dynamically link between element data 808 and other instructional or training data 812, such as video segments. It should be appreciated that content data structures, data format, and data relations may be provided in a many suitable fashions, using a variety of data transfer protocols and data processing techniques. Moreover, the example data architecture 800 is provided as an exemplary data architecture for an example embodiment using martial or self defense techniques, such as Brazilian Jiu Jitsu. It should be appreciated that a data architecture may be tailored to each subject which may be illustrated using a thematically organized map 302, 400, 500, 602. Further, different subjects may be implemented in different host devices 104 which may interface together via a wide variety of networks and protocols.

For exemplary purposes, the present disclosure discusses a thematically organized map 302, 400, 500, 602 of Brazilian Jiu Jitsu elements, however, the disclosed system may be applied to any subject which may be instruction or training. A non-limiting list of examples includes sports and games such as tennis, football, basketball, hockey, volleyball, golf, billiards, darts, poker, bridge, blackjack, chess, backgammon, or other martial arts including boxing, wrestling, judo, kick boxing, recreational activities such as dancing, sailing, fishing, gardening, playing music, or yoga, vocational applications such as wood working, welding, culinary, cooking, cultivation, aviation, medical, surgical, dental, massage therapy, glass blowing, military training, or mining, and many other areas of life, business, or professional practices. The present disclosure may be particularly helpful in dangerous or competitive applications which require repeated decisions of how to further proceed at many instances in a given process.

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
storing a first plurality of elements of a first subject matter, the first plurality of elements including (i) a first plurality of local elements that are specific to the first subject and (ii) a first plurality of non-local elements that relate to the first subject matter and at least a second subject matter which is different from the first subject matter, wherein each of the first plurality of elements includes at least one element connection relationship;
storing a second plurality of elements of the second subject matter, the second plurality of elements including (i) a second plurality of local elements that are specific to the second subject and (ii) a second plurality of non-local elements that relate to the second subject matter and at least the first subject matter, wherein each of the second plurality of elements includes at least one element connection relationship;
causing a user interface to display a map representative of the first plurality of elements connected according to the respective element connection relationships of the first plurality of elements, wherein the first plurality of non-local elements are distinguishable from the first plurality of local elements; and
causing the user interface to dynamically update the map in response to a user interaction with a first non-local element, which is in the first plurality of non-local elements and in the second plurality of non-local elements, to display the second plurality of elements connected according to the respective element connection relationships of the second plurality of elements.

2. The method of claim 1, wherein the first plurality of elements includes a plurality of techniques and a plurality of principles.

3. The method of claim 2, wherein the plurality of principles includes at least one local principle that is only applicable to the first subject matter and at least one non-local principle that is applicable to the first subject matter and the second subject matter.

4. The method of claim 1, wherein a first local element of the first plurality of local elements has at least two connection relationships and is displayed in at least two locations of the map.

5. The method of claim 1, wherein the first non-local element is a universal principle applicable to all subject matters.

6. The method of claim 1, wherein the first plurality of elements relate to at least one of a competitive sport, a competitive activity, a vocational application, and a profession.

7. The method of claim 1, wherein the first plurality of elements relate to martial arts.

8. The method of claim 7, wherein the first plurality of elements includes a plurality of techniques.

9. The method of claim 8, wherein the plurality of techniques includes at least one of an attack, a submission, a position, a transition, a drill and an exercise.

10. The method of claim 1, wherein the first plurality of elements include information relating to outcome probabilities.

11. The method of claim 1, wherein the map accepts feedback relating to the first plurality of elements which is incorporated into the first plurality of elements in an updated version of the map.

12. The method of claim 11, wherein a user tags at least one of the first plurality of elements in the map.

13. The method of claim 1, wherein at least one of the first plurality of elements in the map provides a link to at least one of an instructional video segment and an actual performance video segment.

14. The method of claim 1, wherein a user tags a video segment as relating to at least one of the first plurality of elements.

15. An apparatus comprising:
a memory storing a first plurality of elements of a first subject matter, the first plurality of elements including (i) a first plurality of local elements that are specific to the first subject and (ii) a first plurality of non-local elements that relate to the first subject matter and at least a second subject matter which is different from the first subject matter, and a second plurality of elements of the second subject matter, the second plurality of elements including (i) a second plurality of local elements that are specific to the second subject and (ii) a second plurality of non-local elements that relate to the second subject matter and at least the first subject matter, wherein each of the first plurality of elements and the second plurality of elements includes at least one element connection relationship; and
a processor operably coupled to the memory, the processor executing instructions to:
(i) cause a user interface to display a map representative of the first plurality of elements connected according to the respective element connection relationships of the first plurality of elements, wherein the first plurality of non-local elements are distinguishable from the first plurality of local elements; and
(ii) cause the user interface to dynamically update the map in response to a user interaction with a first non-local element, which is in the first plurality of non-local elements and in the second plurality of non-local elements, to display the second plurality of elements connected according to the respective element connection relationships of the second plurality of elements.

16. A method comprising:
displaying on a user interface a map representative of a first plurality of elements of a first subject matter, the first plurality of elements including (i) a first plurality of local elements that are specific to the first subject and (ii) a first plurality of non-local elements that relate to the first subject matter and at least a second subject matter which is different from the first subject matter, wherein each of the first plurality of elements includes at least one element connection relationship and the first plurality of elements is connected according to the respective element connection relationships of the first plurality of elements, and wherein the first plurality of non-local elements are distinguishable from the first plurality of local elements;
using the user interface to interact with a first non-local element to dynamically update the map, wherein the first non-local element is in the first plurality of non-local elements and in a second plurality of non-local elements included in a second plurality of elements of the second subject matter, the second plurality of elements including (i) a second plurality of local elements that are specific to the second subject and (ii) the second plurality of non-local elements which relate to the second subject matter and at least the first subject matter, wherein each of the second plurality of elements includes at least one element connection relationship; and
displaying on the user interface, in response to the user interaction, the second plurality of elements connected according to the respective element connection relationships of the second plurality of elements.

17. A computer readable medium storing software instructions which, when executed, cause an information processing apparatus to:
store a first plurality of elements of a first subject matter, the first plurality of elements including (i) a first plurality of local elements that are specific to the first subject and (ii) a first plurality of non-local elements that relate to the first subject matter and at least a second subject matter which is different from the first subject matter, wherein each of the first plurality of elements includes at least one element connection relationship;
store a second plurality of elements of the second subject matter, the second plurality of elements including (i) a second plurality of local elements that are specific to the second subject and (ii) a second plurality of non-local elements that relate to the second subject matter and at least the first subject matter, wherein each of the second plurality of elements includes at least one element connection relationship;
cause a user interface to display a map representative of the first plurality of elements connected according to the respective element connection relationships of the first plurality of elements, wherein the first plurality of non-local elements are distinguishable from the first plurality of local elements; and
cause the user interface to dynamically update the map in response to a user interaction with a first non-local element, which is in the first plurality of non-local elements and in the second plurality of non-local elements, to display the second plurality of elements connected according to the respective element connection relationships of the second plurality of elements.

18. The computer readable medium of claim 17, wherein the first plurality of elements includes a plurality of techniques and a plurality of principles.

19. The computer readable medium of claim 18, wherein the plurality of principles includes at least one local principle that is only applicable to the first subject matter and at least one non-local principle that is applicable to the first subject matter and the second subject matter.

20. The computer readable medium of claim 17, wherein a first local element of the first plurality of local elements has at least two connection relationships and is displayed in at least two locations of the map.

21-56. (canceled)
